(19) United States
(12) Patent Application Publication
(10) Pub. No.: US 2007/0268818 A1
(43) Pub. Date: Nov. 22, 2007

(54) Station side transmission unit, operation control method for station side transmission unit, and optical network using station side transmission unit

(75) Inventor: Youichi Sugihara, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/798,732

(22) Filed: May 16, 2007

(30) Foreign Application Priority Data
May 17, 2006 (JP) 137150/2006

(51) Int. Cl. H04J 1/16

(52) U.S. Cl. 370/216

(57) ABSTRACT

A station side transmission unit in an optical network includes two redundant modules. An interface of each of the redundant modules for connection to an outside of the station side transmission unit includes a function of releasing closure of the interface. One of the redundant modules serves as an active module and the other serves as a backup module. During occurrence of a loss of signal, the active module closes the interface of the active module and the backup module releases closure of the interface of the backup module, whereby reliability and availability of an access network are improved.

### BACKGROUND OF THE INVENTION

1. Field of the Invention

The present invention relates to a station side transmission unit, an operation control method for the station side transmission unit, and an optical network using the station side transmission unit. More specifically, the present invention relates to improvement of an optical network having redundant configuration to improve reliability and availability of an access network.

2. Description of the Related Art

In conventional internet services, instantaneous interruption of services has been allowed to some extent. However, because of recent development of technologies and extension of network infrastructure, the number of services that lay stress on real time performance, e.g., IP (Internet protocol) telephony, Internet broadcasting, and teleconference, has increased. As a result, demands for improving reliability and availability of an access network have risen.

For example, in a PON (passive optical network) system used as an optical communication network system, one optical fiber is shared among a plurality of users. Therefore, the PON system is an efficient and economical technique in that a high-speed and massive-capacity optical line is available. However, the PON system has the following disadvantage. As shown in FIG. 1, a star coupler 3 is employed in a PON zone 4 in which optical signals are transmitted and received. Due to this, the relationship between an OLT (optical line terminal) module 13 and ONUs (optical network units) 21 to 2n is a one-to-n relationship, which disadvantageously deteriorates reliability of an access network in the PON system. In FIG. 1, the reference numeral 5 denotes a switch provided between the OLT 1 and the Internet.

In the configuration of the conventional PON system, only one optical fiber cable is physically present between the star coupler 3 and the OLT module 13. As a result, if a network failure such as a failure of the OLT module 13 or breakage of the optical fiber occurs, n×m services for all of m users of the ONUs 21 to 2n stop.

Moreover, once the services stop for the above-stated reason, the services are not generally recovered unless a maintenance person visits a failure site and copes with replacement of the optical fiber or OLT module to which the failure occurs. Under these circumstances, demand rises for establishment of framework that can ensure high reliability and high availability matching recent Internet services.

Referring to techniques disclosed in Japanese Patent Application Laid-Open Nos. 2002-218008 (document 1) and 2005-328294 (document 2), configurations that can ensure high reliability and high availability of the access network by duplexing an OLT function are disclosed.

Although the techniques disclosed in documents 1 and 2 thus ensure high reliability and high availability of the access network by duplexing the OLT function, it is necessary to include switching means for switching over the duplexed OLT functions and switching control means for controlling the switching means in the network system. It is also necessary to redesign each OLT module to be adapted to the duplexed OLT functions. As a result, the techniques disclosed in documents 1 and 2 disadvantageously face cost increase and inability to downsize the unit.

### SUMMARY OF THE INVENTION

Disclosed herein are a station side transmission unit, an operation control method for the station side transmission unit, and an optical network using the station side transmission unit capable of preventing cost increase and preventing growing in size, constructing a PON system in which redundant OLT modules are installed and redundant communication lines are arranged, and ensuring higher reliability and higher availability of an access network.

According to a first aspect of the present invention, there is provided a station side transmission unit in an optical network, comprising a plurality of modules, wherein each of the modules includes means that closes and opens an interface for each of the modules connecting to an outside of the station side transmission unit.

Since a line between OLTs and a star coupler has redundancy, even if a failure occurs, switching of OLT modules is automatically performed and a network advantageously possesses high reliability. That is, as long as one of the OLT modules functions normally, it is possible to continue to provide services to end users.

Furthermore, a request for switching of OLT modules, via which a communication is held to another OLT module, can be transmitted at arbitrary timing set by a maintenance person. It is therefore possible to flexibly perform a maintenance operation. For example, even if it is necessary to update software to be accompanied by restart of one of the OLT modules, it is advantageously possible to avoid time and labor for notifying each user of a maintenance operation, a time restriction on performance of the maintenance operation and the like. In other words, the redundant configuration can prevent the maintenance operation from badly influencing the end users.

Moreover, since the function of automatically closing an interface of an OLT to which the failure occurs is used during a failure, there is no need to include switching means and switching control means in each OLT module. It is, therefore, advantageously possible to prevent the cost increase and the growth in size of the PON system.

### BRIEF DESCRIPTION OF THE DRAWINGS

Features of the disclosed embodiments will be described by way of the following detailed description with reference to the accompanying drawings in which:

FIG. 1 is a block diagram of a conventional PON system;

FIG. 2 is a block diagram of a PON system according to a first embodiment;

FIG. 3 is a schematic diagram showing operation performed in the PON system according to the first embodiment;

FIG. 4 is a conceptual diagram of a star coupler 3 according to the first embodiment;

FIG. 5 is a sequence diagram for explaining the operation performed in the PON system according to the first embodiment;

FIG. 6 is a block diagram of a PON system according to a second embodiment.

### DESCRIPTION OF EXEMPLARY EMBODIMENTS

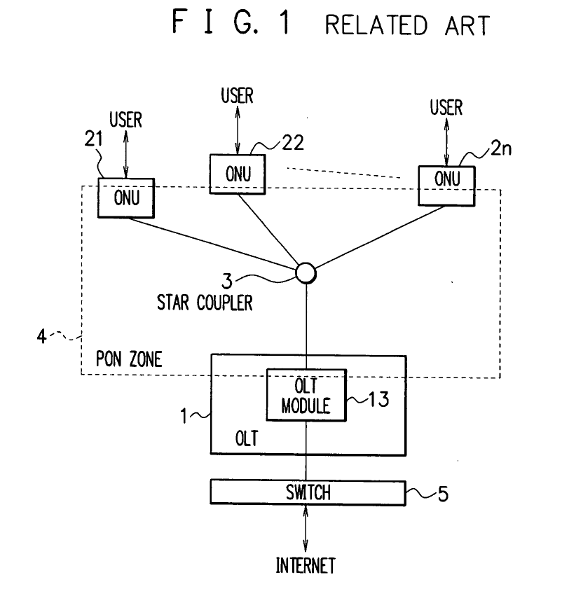

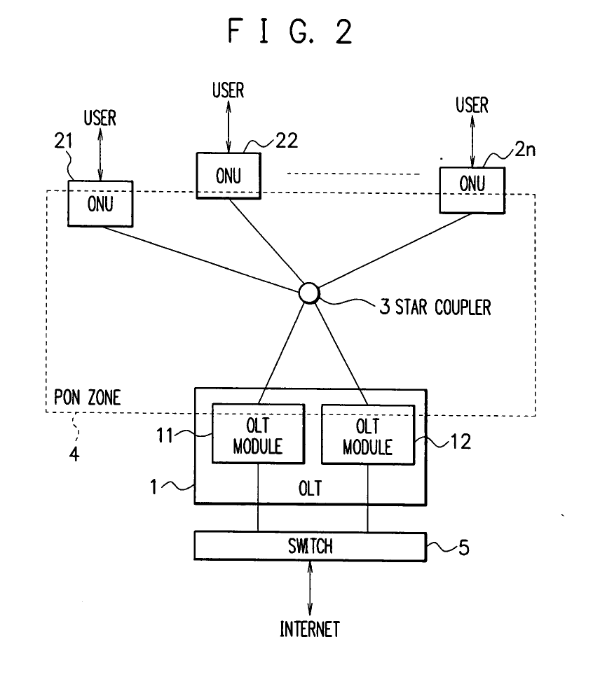

Exemplary embodiments will be described hereinafter with reference to the accompanying drawings. FIG. 2 is a block diagram of a PON system according to a first embodiment. In FIG. 2, the same constituent elements as those shown in FIG. 1 are denoted by the same reference numerals. Referring to FIG. 2, the reference numeral 1 denotes an OLT of the PON system, and the OLT 1 is generally configured to include a plurality of independent OLT modules (cards) 11 and 12. The OLT 1 is disposed in a station, and ONUs 21 to 2n are disposed in respective user (subscriber) houses. A combination of the OLT 1 and the ONUs 21 to 2n serve as a data transmission unit converting an optical signal into an electric signal or an electric signal into an optical signal, and transmitting and receiving data. The reference numeral 3 denotes a star coupler (or an optical coupler) that splits received optical signals and transmits signals.

Further, the reference numeral 4 denotes a zone referred to as “PON zone” in which optical communication is held using an optical fiber. The reference numeral 5 denotes a switch that is a Layer 2 device according to an OSI (open systems interconnection) reference model established by ISO (International Organization for Standardization). The switch 5 is provided outside of the OLT 1 and independently of the OLT 1, and connected to the OLT modules 11 and 12.

In the PON system shown in FIG. 2, OLT modules included in the OLT 1 forms a duplex (redundant) system (by a command input or the like of a maintenance person). One is used as an active OLT module and the other is used as a backup OLT module. In FIG. 2, it is assumed that the OLT module 11 is the active module and the OLT module 12 is the backup module.

An optical signal transmitted from one of the ONUs 21 to 2n is split into two optical signals by the star coupler 3 toward the OLT modules 11 and 12. However, even if both of the OLT modules 11 and 12 are physically connected to the ONUs 21 to 2n, one of the OLT modules 11 and 12 is always in a down state. Namely, in a communication using the active module 11, a PON interface (I/F), not shown, of the backup module 12 is closed. Furthermore, in a communication using the backup module 12, a line between the active module 11 and the star coupler 3 is down due to a failure. Therefore, the optical signal is transmitted only to one of the OLT modules 11 and 12 whether a failure occurs or not.

It is assumed that when one of OLT modules is duplex, the active module 11 and the backup module 12 share unique information, e.g., optical level up/down information, spectrum information, authentication information, application information characteristic of the PON system (such as MAC (media access control) learning information and group member information on IGMP (Internet Group Management Protocol)) that vary among the respective ONUs 21 to 2n.

While a normal communication is being held, the backup module 12 is set into a standby state in which a PON I/F and an SNI (service node interface), not shown, of the backup module 12 are closed so as to prevent frame wraparound and repeated reception. The SNI is an I/F of the OLT module connected to the switch 5.

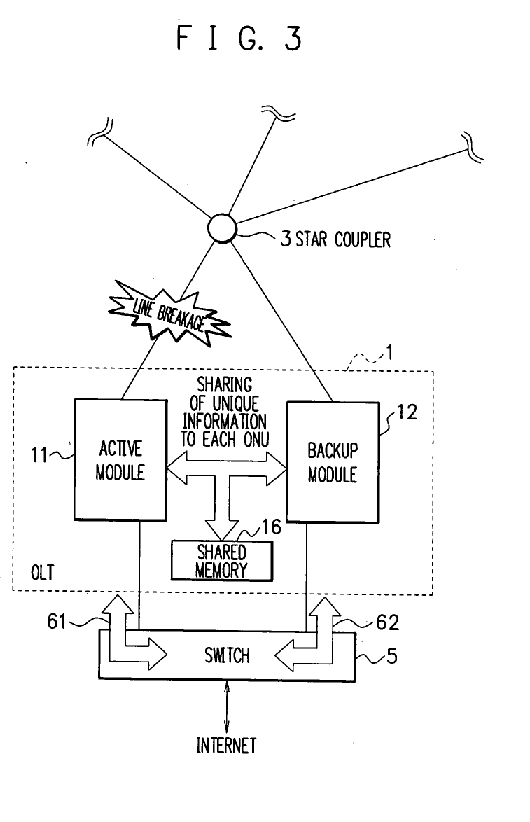

Therefore, as shown in FIG. 3, every communication between each user and the Internet is held on a route passing through an arrow 61 of the switch 5 via the active module 11 whether the communication is a downstream (a communication from the Internet to an end user) or an upstream (a communication from the end user to the Internet). In the first embodiment, a state of the PON system in which the communication is held on this route will be referred to as “normal state”.

As shown in FIG. 3, if the optical fiber between the star coupler 3 and the SNI of the active module 11 is broken, the OLT 1 detects occurrence of a line failure and transmits a request of communication path switching to the active module 11 and the backup module 12. In response to the request, the active module 11 closes the SNI of the active module 11 and the backup module 12 releases closure of the PON I/F and the SNI of the backup module 12.

When the switch 5 detects that the line connected to the active module 11 is down and the line connected to the backup module 12 is up, the switch 5 starts transferring frames to the backup module 12 on a route passing through an arrow 62 and stops transferring frames to the active module 11 on the route passing through the arrow 61. In this manner, during the line failure, every communication is held via the backup module 15 whether the communication is a downstream or an upstream.

When the line is recovered from the failure, the OLT 1 detects a line recovery and transmits a request of communication path switching to the active module 11 and the backup module 12. In response to the request, the active module 11 releases closure of the SNI of the active module 11 and the backup module 12 closes the PON I/F and the SNI of the backup module 12. Upon detecting that the line connected to the active module 11 is up and the line connected to the backup module 12 is down, the switch 5 transfers all frames to the active module 11 on the route passing through the arrow 61 again. The PON system thereby turns into the normal state.

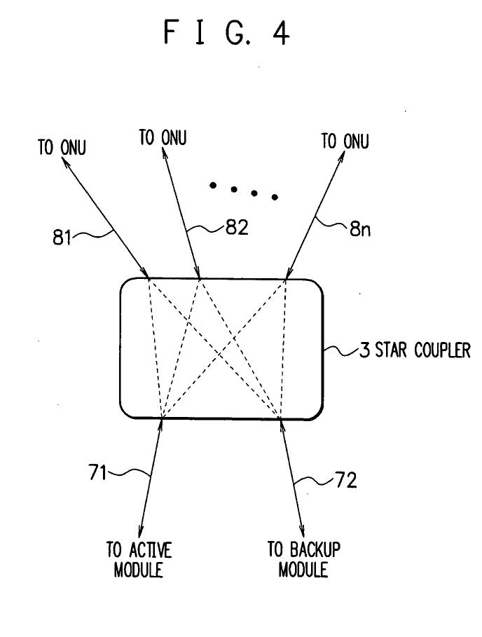

The star coupler 3 included in the PON system according to the first embodiment will be described with reference to FIG. 4. As the star coupler 3, a star coupler that splits an optical signal in a two-to-n relationship is prepared as shown in FIG. 4. Optical signals from the active module 11 and the backup module 12 are transmitted to the star coupler 3 via optical fibers 71 and 72, respectively. The star coupler 3 splits each of the optical signals transmitted from the active module 11 and the backup module 12 into n optical signals, and transmits the n optical signals to optical fibers 81 to 8n connected to the respective ONUs 21 to 2n. Likewise, in an reverse-direction communication from ONU side to OLT side, an optical signal from each of the ONUs 21 to 2n is split into two optical signals by the star coupler 3 and the two split optical signals are transmitted to the optical fibers 71 and 72 connected to the active module 11 and the backup module 72, respectively.

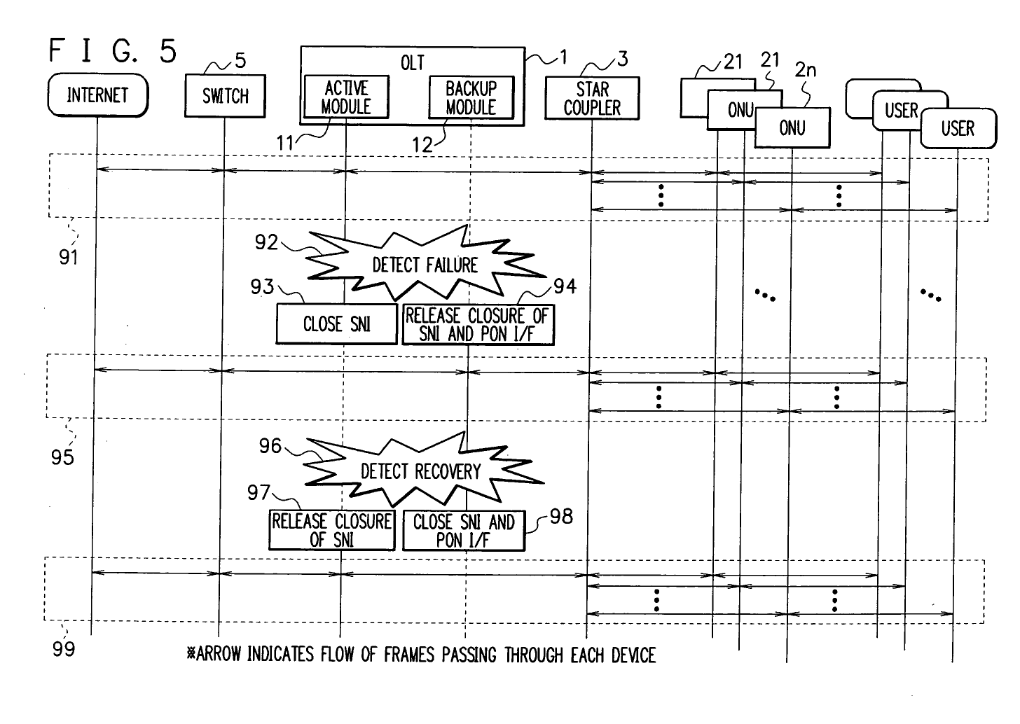

Operation performed in the PON system having the redundant configuration shown in FIG. 2 will next be described with reference to the sequence diagram of FIG. 5. In FIG. 5, a broken-line frame 91 indicates the communication route when the PON system is in the normal state. In the normal state of the PON system, the backup module 12 is set on standby such that the SNI and PON I/F of the backup module 12 are both closed. Due to this, all communications between the Internet and each user are held via the active module 11.

When the optical fiber connecting the active module 11 to the star coupler 3 is broken or the active module 11 fails, the OLT 1 detects a failure (92) and transmits a request of switching of communication route to the active module 11 and the backup module 12. In response to the request, the active module 11 closes the SNI of the active module 11 so that the switch 5 cannot transfer frames to the active module 11 (93), and the backup module 12 activates the PON I/F and the SNI of the backup module 12 so as to be able to start communication via the backup module 12 (94).

A broken-line frame 95 indicates the communication route during occurrence of the failure. As indicated by the broken-line frame 95, the switch 5 detects that the line connected to the active module 11 is down and the line connected to the backup module 12 is up. Therefore, the switch 5 stops transferring frames to the active module 11 and starts transferring frames to the backup module 12. All the communications are, therefore, held via the backup module 12.

When the OLT 1 detects a line recovery from the communication failure between the active module 11 and the star coupler 3 (96), the OLT 1 transmits a request of switching of communication route to the active module 11 and the backup module 12. In response to the request, the active module 11 activates the SNI of the active module 11 so as to resume communications via the active module 11 (97), and the backup module 12 closes the PON I/F and the SNI of the backup module 12 so that the backup module 12 returns to the standby state (98).

The switch 5 detects that the line connected to the active module 11 is up and that the line connected to the backup module 12 is down. Accordingly, the switch 5 starts transferring frames to the active modules 11 and stops transferring frames to the backup module 12. In this manner, as indicated by a broken-line frame 99, all the communications are held again via the active module 11 and the PON system turns into the normal state.

To close or open the I/Fs (PON I/Fs and SNIs) of the active module 11 and the backup module 12, a well-known function normally mounted in an I/F of a personal computer or an I/F of a network unit can be used. For example, when a failure occurs, loss of signal (LOS) occurs. HW (hardware) detects this LOS and notifies SW (software) that controls the station side transmission unit of the LOS. In response to the notification, the SW changes from a switch incorporated in the defective I/F to another switch to control the station side transmission unit not to transmit or receive electric and optical signals via the defective I/F.

As can be understood, according to the first embodiment, by integrating the OLT modules 11 and 12 into one star coupler 3, the PON line that is originally one PON line has redundancy. Therefore, even if one line is broken or a certain OLT module fails, it is possible to continue to provide services to end users as long as communications are held via one of the OLT modules.

Moreover, even if a failure occurs, a processing for closing the I/Fs of an OLT module to which the failure occurs is automatically performed. Therefore, there is no need to additionally include means for switching transmission lines in each OLT module, and an existing OLT can be used as the OLT 1 of the PON system according to the first embodiment. It is thereby possible to prevent cost increase and growth in size of the PON system.

Furthermore, with the redundant configuration using a plurality of OLT modules, a maintenance person responsible for maintenance of the OLT 1 can switch over to an OLT module used for communication at arbitrary timing. Therefore, in a software update operation accompanied by restart of one of the OLT modules, for example, a maintenance operation can be performed without stopping providing services to the end users.

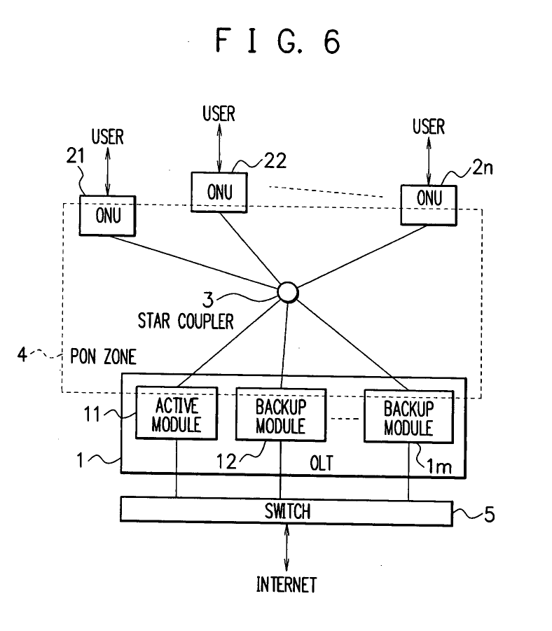

FIG. 6 is a block diagram of a PON system according to a second embodiment. In FIG. 6, the same constituent elements as those shown in FIG. 2 are denoted by the same reference numerals. In the second embodiment, a star coupler 3 splits optical signals in an n-to-m relationship. Furthermore, an OLT module includes one active module 11 and a plurality of backup modules 12 to 1m. According to the second embodiment, it is possible to construct a PON system having higher reliability.

As another exemplary embodiment, controlling operations performed in a station side transmission unit may comprise the steps of causing one of the plurality of modules to serve as an active module and remainders of the plurality of modules to serve as backup modules; and closing an interface of the active module and opening an interface of each of the backup modules in response to a loss of signal.

As a further exemplary embodiment, there is provided an optical network comprising the station side transmission unit.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

1. A station side transmission unit in an optical network, comprising a plurality of modules,
wherein each of the modules includes means that closes and opens an interface for each of the modules connecting to an outside of the station side transmission unit.

2. The station side transmission unit according to claim 1,
wherein one of the modules is an active module and the other modules are backup modules, and
the means included in the active module closes the interface of the active module and the means included in each of the backup modules opens the interface of each of the backup modules when a loss of signal occurs.

3. The station side transmission unit according to claim 2,
wherein during a signal recovery, the means included in the active module opens the interface of the active module and the means included in each of the backup modules closes the interface of each of the backup modules.

4. An optical network comprising the station side transmission unit according to claim 1.

5. A method of controlling operations performed in a station side transmission unit including a plurality of redundant modules in an optical network, the method comprising the steps of:
causing one of the modules to serve as an active module and the other modules to serve as backup modules; and
closing an interface of the active module and opening an interface of each of the backup modules in response to a loss of signal.

6. The method according to claim 5, further comprising a step of opening the interface of the active module and closing the interface of each of the backup modules in response to a signal recovery.

7. An optical network comprising the station side transmission unit according to claim 2.

8. An optical network comprising the station side transmission unit according to claim 3.
